(19) United States
(12) Patent Application Publication
(10) Pub. No.: US 2025/0100296 A1
(43) Pub. Date: Mar. 27, 2025

(54) INKJET IMAGE FORMING APPARATUS

(71) Applicant: KYOCERA Document Solutions Inc., Osaka (JP)

(72) Inventor: Nobuhiro MAEZAWA, Osaka-shi (JP)

(73) Assignee: KYOCERA Document Solutions Inc., Osaka (JP)

(21) Appl. No.: 18/893,900

(22) Filed: Sep. 23, 2024

(30) Foreign Application Priority Data
Sep. 25, 2023 (JP) 2023-159441

(51) Int. Cl. B41J 11/00; B41J 3/407; B41J 29/00

(52) U.S. Cl. CPC B41J 11/0015; B41J 3/407; B41J 29/00

(57) ABSTRACT

An ink jet image forming apparatus includes a head unit, a corona treatment unit, and a control part. The head unit ejects ink on a printing base material conveyed in a predetermined conveyance direction. The corona discharge treatment unit is disposed on an upstream side of the head unit in the conveyance direction and performs a corona discharge on the printing base material. The control part controls a discharge amount of the corona discharge performed by the corona discharge treatment unit. The control part controls the discharge amount based on a glossiness of the printing base material.

### INCORPORATION BY REFERENCE

This application is based on and claims the benefit of priority from Japanese patent application No. 2023-159441 filed on Sep. 25, 2023, which is incorporated by reference in its entirety.

### BACKGROUND

The present disclosure relates to an inkjet image forming apparatus which forms an image on a printing base material by an inkjet method.

In the inkjet image forming apparatus, corona discharge is sometimes applied to the printing base material in order to improve adhesion between the printing base material and ink.

An amount of the corona discharge may be set with reference to a table for associating the paper base material (corresponding to the printing base material) with a type of the ink.

However, in the above case, the corona discharge treatment is performed to compensate for a difference in glossiness between the printed area and the non-printed area, and characteristics of the printing base material are not considered.

### SUMMARY

An ink jet image forming apparatus according to the present disclosure includes a head unit, a corona treatment unit, and a control part. The head unit ejects ink on a printing base material conveyed in a predetermined conveyance direction. The corona discharge treatment unit is disposed on an upstream side of the head unit in the conveyance direction and performs a corona discharge on the printing base material. The control part controls a discharge amount of the corona discharge performed by the corona discharge treatment unit. The control part controls the discharge amount based on a glossiness of the printing base material.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inkjet image forming apparatus according to one embodiment of the present disclosure.

FIG. 2 is a view schematically showing a corona treatment unit in the inkjet image forming apparatus according to the embodiment of the present disclosure.

FIG. 3 is a plan view schematically showing a head unit in the inkjet image forming apparatus according to the embodiment of the present disclosure.

FIG. 4A is a view showing a result (the present example) of a tape peeling test in the inkjet image forming apparatus according to the embodiment of the present disclosure.

FIG. 4B is a view showing a result (a comparative example) of the tape peeling test in the inkjet image forming apparatus according to the embodiment of the present disclosure.

### DETAILED DESCRIPTION

Hereinafter, with reference to the attached drawings, an inkjet image forming apparatus according to one embodiment of the present disclosure will be described.

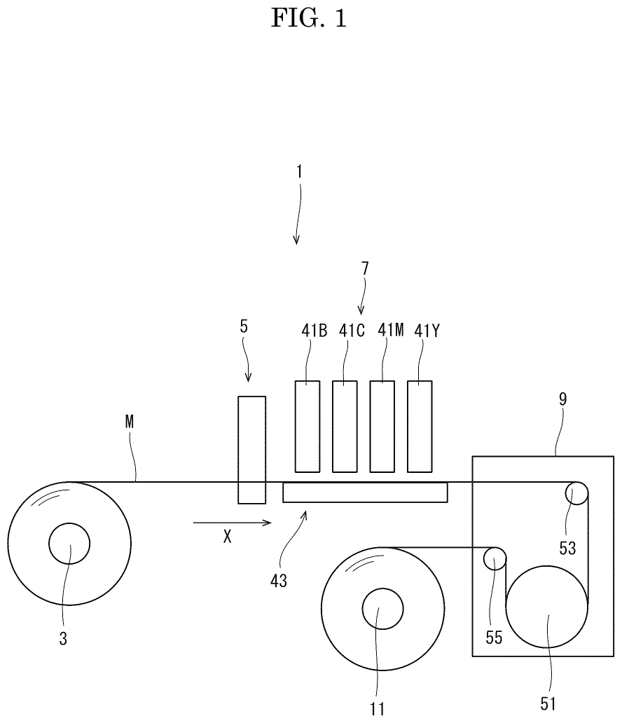

With reference to FIG. 1, the entire structure of the inkjet image forming apparatus 1 will be described. FIG. 1 is a front view schematically showing the internal structure of the inkjet image forming apparatus 1.

The inkjet image forming apparatus 1 includes a supply roller 3 around which a long printing base material M is wound, a corona treatment unit 5 which applies corona discharge to the printing base material M supplied from the supply roller 3, an image forming part 7 which forms an image on the printing base material M applied with the corona discharge, by an inkjet method, a drying part 9 which dries the image formed by the image forming part 7, and a winding roller 11 which winds the printing base material M dried by the drying part 9.

First, the supply roller 3 will be described. The printing base material M is wound and mounted on the supply roller 3. When the supply roller 3 rotates, the printing base material M is fed out in a predetermined conveyance direction X.

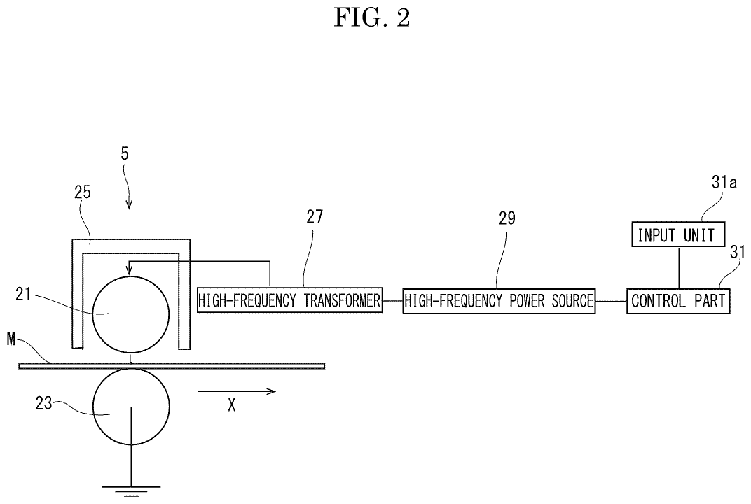

Next, the corona treatment unit 5 will be described with reference to FIG. 2. FIG. 2 is a view schematically showing the corona treatment unit 5. The corona treatment unit 5 is arranged on the downstream side of the supply roller 3 in the conveyance direction X. The corona treatment unit 5 is provided with a corona discharge electrode 21 and a counter roller 23 arranged at a predetermined interval from the corona discharge electrode 21. The corona discharge electrode 21 is made of, for example, rod-shaped ceramic or aluminum cylinder coated with ceramic, elongated in the width direction Y of the printing base material M. The counter roller 23 is made of, for example, stainless steel cylinder, and is grounded. The interval between the corona discharge electrode 21 and the counter roller 23 is, for example, 0.5 to 2.0 mm. Tension rollers may be arranged on the upstream side and the downstream side of the counter roller 23.

The corona discharge electrode 21 is covered with an electrode cover 25 whose lower surface is opened. The corona discharge electrode 21 is connected to a high-frequency power source 29 through a high-voltage transformer 27. The high-frequency power source 29 generates a high-frequency AC current. The high-frequency AC current is, for example, 5.5 kV to 6.5 kV. The higher the discharge power, the higher the discharge voltage (discharge amount). However, since the discharge voltage varies depending on an atmospheric pressure, temperature and humidity, or the others, the discharge voltage is set depending on environmental conditions when the corona discharge treatment is actually performed. The high-voltage transformer 27 amplifies the generated high-frequency AC current, converts it into discharge power, and applies it to the corona discharge electrode 21. Thus, corona discharge is generated between the corona discharge electrode 21 and the counter roller 23.

The high-frequency power source 29 is electrically connected to a control part 31, and generates a high-frequency AC current based on an instruction from the control part 31.

Next, the image forming part 7 will be described with reference to FIG. 1. The image forming part 7 is arranged on the downstream side of the corona treatment unit 5 in the conveyance direction X. The image forming part 7 is provided with four head units 41B, 41C, 41M, and 41Y corresponding to inks of four colors (black, cyan, magenta, and yellow) (collectively referred to as a head unit 41), and a conveying plate 43 on which the printing base material M is conveyed along the surface.

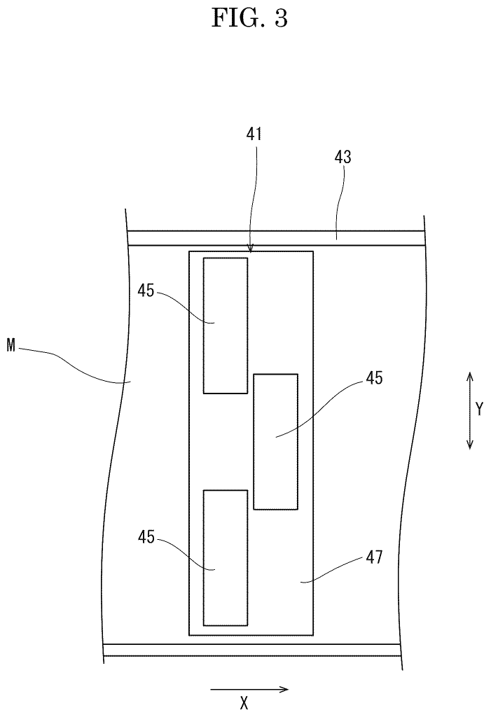

The head unit 41 will be described with reference to FIG. 3. FIG. 3 is a plan view showing the head unit 41. The head unit 41 includes three print heads 45 and a plate 47 for supporting the three print heads 45.

As shown in FIG. 3, the three print heads 45 are disposed in a staggered pattern along the width direction Y (a line head system) so as to have the same width as that of the printing base material M, and are supported by the plate 47. The print head 45 includes a number of nozzles (not shown). The ejection port of the nozzle is opened on the lower surface of the print head 45.

The four head units 41 are arranged in order along the conveyance direction X, and the black, cyan, magenta and yellow inks are supplied respectively. The supplied ink is ejected downward from the ejection port of the nozzle of each print head 45.

As shown in FIG. 1, the conveying plate 43 is disposed below the four head units 41. The upper surface of the conveying plate 43 is formed flat. As shown in FIG. 3, the width of the conveying plate 43 is wider than a width of the printing base material M and all the head units 41. A heat source (not shown) is provided below the conveying plate 43 to heat the conveying plate 43 to a predetermined temperature. The conveying plate 43 is made of metal, for example.

Next, the drying part 9 will be described. The drying part 9 is arranged on the downstream side of the image forming part 7 in the conveyance direction X. The drying part 9 includes a heat drum 51, and upstream-side and downstream-side tension rollers 53 and 55 arranged on the upstream side and the downstream side of the heat drum 51. The printing base material M passing through the image forming part 7 is wound around the heat drum 51 between the upstream-side and downstream-side tension rollers 53 and 55. The heat drum 51 is heated to dry the printing base material M conveyed along the surface.

Next, the winding roller 11 will be described. The winding roller 11 is arranged on the downstream side of the drying part 9 in the conveyance direction X. The end of the printing base material M is fixed to the winding roller 11. The winding roller 11 is connected to a motor (not shown) and rotated. By rotating the winding roller 11 in a predetermined direction at a predetermined rotational speed by the motor, the printing base material M is fed out from the supply roller 3.

The fed printing base material M passes between the corona discharge electrode 21 and the counter roller 23 of the corona treatment unit 5, and is conveyed to the image forming part 7. In the image forming part 7, the printing base material M is conveyed toward the drying part 9 along the upper surface of the conveying plate 43 under the four head units 41. Then, after being wound around the heat drum 51 in the drying part 9, it is wound up by the winding roller 11.

Next, the control part 31 will be described. As shown in FIG. 2, the control part 31 controls the high-frequency power source 29 of the corona treatment unit 5 to generate a high-frequency current of a predetermined intensity. Further, the control part 31 includes an input unit 31a such as a display panel. The input unit 31a includes a glossiness input unit for inputting a glossiness (for example, 20 degrees glossiness) of the printing base material M. The control part 31 is also electrically connected to the head units 41 and controls the head units 41 based on the input image data.

The image forming operation of the inkjet image forming apparatus 1 having the above configuration will be described. In the image forming operation, first, the user inputs a glossiness (20 degrees glossiness) of the printing base material M to the input unit 31a of the control part 31. When the inputted glossiness is 25 or higher, the control part 31 controls the corona treatment unit 5 so as to perform the corona discharge.

Thereafter, the motor is driven to rotate the winding roller 11, and the printing base material M is fed from the supply roller 3 to the corona treatment unit 5. In the corona treatment unit 5, the corona discharge is generated between the corona discharge electrode 21 and the counter roller 23, and the upper surface of the printing base material M is subjected to the corona discharge. On the other hand, when the input glossiness is lower than 25, the control part 31 controls the corona treatment unit 5 so as not to perform the corona discharge. That is, when the input glossiness is lower than 25, the corona discharge treatment is not performed.

Thereafter, the printing base material M is conveyed below the head units 41, and the ink of a predetermined color is ejected from the corresponding head unit 41 based on the image data to form an image on the printing base material M. The printing base material M on which the image is formed is conveyed to the drying part 9. In the drying part 9, the ink is completely dried. Thereafter, the printing base material M is wound up by the winding roller 11.

As described above, according to the present disclosure, the corona discharge is applied to the printing base material M when a glossiness of the printing base material M is equal to a constant value or higher, more specifically, when the 20 degrees glossiness is equal to 25 or higher. The printing base material M having a low glossiness has fine irregularities on its surface, and the ink easily penetrates these irregularities (anchor effect), thereby enhancing the adhesion between the ink and the printing base material M. For example, in the case of the printing base material M such as a plain paper having a 20 degrees glossiness lower than 25, the corona discharge treatment is not required.

However, the printing base material M such as a plastic film or synthetic paper having a 20 degrees glossiness of 25 or higher has low adhesion to the ink. Thus, by performing the corona discharge treatment, the adhesion of the ink to the printing base material M can be enhanced. That is, when the printing bae material M is subjected to the corona discharge treatment, fine irregularities are formed on the surface of the printing base material M, and the above-mentioned anchor effect is obtained. Further, hydrophilic polar groups such as carbonyl groups, carboxyl groups and nitrides are formed on the surface of the printing base material M. Such a polar group enhances a wettability of the surface of the printing base material M. Thus, the physical and chemical actions of the corona discharge treatment improve the compatibility (adhesion) between the printing base material M and the ink.

In order to improve the compatibility (adhesion) between the printing base material M and the ink, a precoating treatment using a precoating liquid may be performed. However, in the precoating treatment, since the liquid is applied, it is necessary to dry the printing base material M, and it is necessary to increase the treatment time for the drying time or to provide a drying device. In the corona discharge treatment, the effect equivalent to the precoating treatment can be obtained without using a liquid. However, the precoating treatment may be performed together depending on a type of the ink.

Next, a test in which a relationship between glossiness and adhesion is evaluated in the inkjet image forming apparatus 1 of this embodiment will be described. The printing base material M is placed on a white area of a concealment ratio test paper (manufactured by TP Giken Co., Ltd.), and the 20 degrees glossiness is measured using a glossimeter (Trade name, J480T-268, manufactured by Elcometer). The adhesion is evaluated by a peeling test.

The peeling test is carried out by the following method. A cyan printed solid image is printed on the printing base material M at 600 dpi. The printing base material is an OPP film, a width of the printing base material is 210 mm, and a conveying speed of the printing base material is 3 m/min.

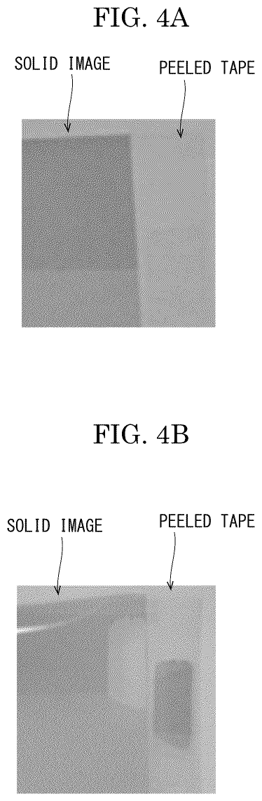

The printed image is subjected to a peeling test based on JISK5600 (no cross cut is formed). The tape (Trade name, CT, manufactured by NICHIBAN) is firmly rubbed onto the image with a fingertip, and within 5 minutes, the tape is peeled off, or the edge of the tape is grasped at an angle of close to 60 degrees and surely peeled off within 0.5 to 1.0 seconds. The images after the peeling are shown in FIG. 4A and FIG. 4B. The peeled tape is attached to the right side of the printing base material shown on the left side. FIG. 4A shows a present example of the present disclosure and FIG. 4B shows a comparative example.

In the present example, the corona discharge treatment is applied to the printing base material by the corona treatment unit. A discharge power is 100 W (a discharge voltage is 6.3 kV). In the comparative example, the printing base material is not subjected to the corona discharge treatment. As can be seen from FIG. 4A and FIG. 4B, in the present example, the ink is not peeled from the printing base material and is not deposited on the peeled tape. Onn other hand, in the comparative example, the ink is separated from the printing base material and adhered to the tape.

The control part 31 may control the corona treatment unit 5 so that the higher the glossiness, the higher the voltage applied to the corona discharge electrode. In this case, even when the printing base material has a high glossiness and a low adhesion to the ink, the adhesion to ink can be enhanced. The image forming apparatus 1 may be provided with a measuring unit (not shown) for measuring a glossiness of the printing base material M. In this case, after the printing base material M is set, a glossiness of the printing base material M is measured by the measuring unit. The control part 31 may control the corona treatment unit 5 to perform the corona discharge based on the measured value. In this case, the user does not need to input the glossiness.

In the embodiments described above, the four color head units 41 are used, but the present disclosure is not limited to the four colors, and may be more or less than four colors. The head unit 41 is not limited to the line head system. However, the line head system is preferable because the printing speed can be increased. Although a long plastic film (PET film) is used as the printing base material M, a cut film may be used.

Although the present disclosure has been described with respect to specific embodiments, the present disclosure is not limited to the above embodiments. Without departing from the scope and spirit of the present disclosure

1. An ink jet image forming apparatus comprising:
a head unit which ejects ink on a printing base material conveyed in a predetermined conveyance direction;
a corona discharge treatment unit disposed on an upstream side of the head unit in the conveyance direction and performing a corona discharge on the printing base material; and
a control part controlling a discharge amount of the corona discharge performed by the corona discharge treatment unit, wherein
the control part controls the discharge amount based on a glossiness of the printing base material.

2. The inkjet image forming apparatus according to claim 1, wherein
the control part includes an input unit to which a glossiness of the printing base material is input.

3. The inkjet image forming apparatus according to claim 1, wherein
the control part controls the corona discharge treatment unit so as to perform the corona discharge when a glossiness of the printing base material is a predetermined value or higher.

4. The inkjet image forming apparatus according to claim 1, wherein
the control part controls the corona discharge treatment unit so as to perform the corona discharge when a 20 degrees glossiness of the printing base material is 25 or higher.

5. The inkjet image forming apparatus according to claim 1, wherein
the printing base material is a plastic film.
